(19) United States
(12) Patent Application Publication
(10) Pub. No.: US 2025/0258651 A1
(43) Pub. Date: Aug. 14, 2025

(54) MODULAR MULTIPLIER WITH IMPROVED EFFICIENCY

(71) Applicant: FortifyIQ, Inc., Concord, MA (US)

(72) Inventors: Yaacov Belenky, Maale Adumim (IL); Ury Kreimer, Tekoa (IL); Valery Teper, Petah-Tikva (IL); Daria Ryzhkova, Moscow (RU); Alexander Kesler, Boca Raton, FL (US)

(21) Appl. No.: 19/049,329

(22) Filed: Feb. 10, 2025

Related U.S. Application Data
(60) Provisional application No. 63/551,887, filed on Feb. 9, 2024.

(51) Int. Cl. G06F 7/72

(52) U.S. Cl. CPC G06F 7/722

(57) ABSTRACT

A method for performing modular multiplication of a first multiplicand and a second multiplicand in a cryptographic engine, the method including calculating an integer corresponding with an inverse of a modulus based on a number of bits in the modulus, a digit size of the modular multiplier and a fixed size coefficient. The method also includes calculating a result of the modular multiplication using a plurality of modular reduction coefficients determined using the integer and respective digits of the multiplicands, the result less than an upper size limit that is based on the size coefficient and the modulus. The method further includes determining a final result of the modular multiplication based on a difference between the result and the modulus. If the difference is less than zero, the result is the final result, and if the difference is greater than or equal to zero, the difference is the final result.

### CROSS-REFERENCE TO RELATED APPLICATION

This application claims the benefit of U.S. Provisional Application No. 63/551,887, filed on Feb. 9, 2024, which is hereby incorporated by reference in its entirety.

### SUMMARY

In a general aspect, a method for performing modular multiplication of a first integer and a second integer modulo a third integer in a modular multiplier of a cryptographic engine includes calculating a fourth integer corresponding with an inverse of the third integer based on a number of bits in the third integer, a digit size of the modular multiplier and a size coefficient. The size coefficient corresponds with an upper size limit for a result of the modular multiplication. The size coefficient is fixed and the upper size limit is a product of the size coefficient and the third integer. The method further includes calculating a result of the modular multiplication using a plurality of modular reduction coefficients that are determined using the fourth integer, a respective digit of the first integer and at least two most significant digits of the second integer. The result has a value that is less than the upper size limit. The method also includes determining a final result of the modular multiplication based on a difference between the result and the third integer. If the difference is less than zero, the result is the final result, and if the difference is greater than or equal to zero, the difference is the final result.

In another general aspect, a processor includes a cryptographic engine configured to perform modular multiplication of a first integer and a second integer modulo a third integer. Performing the modular multiplication includes calculating a fourth integer corresponding with an inverse of the third integer based on a number of bits in the third integer, a digit size of a hardware multiplier of the processor and a size coefficient. The size coefficient corresponds with an upper size limit for a result of the modular multiplication. The size coefficient is fixed and the upper size limit is a product of the size coefficient and the third integer. Performing the modular multiplication further includes calculating a result of the modular multiplication using a plurality of modular reduction coefficients that are determined using the fourth integer, a respective digit of the first integer, and at least two most-significant digits of the second integer. The result has a value that is less than the upper size limit. Performing the modular multiplication also includes determining a final result of the modular multiplication based on a difference between the result and the third integer. If the difference is less than zero, the result is the final result. If the difference is greater than or equal to zero, the difference is the final result.

### BRIEF DESCRIPTION OF THE DRAWINGS

FIG. 1 is a flowchart illustrating an example method for performing modular multiplication.

FIG. 2 is a flowchart illustrating another example method for performing modular multiplication, which can be an implementation of the method of FIG. 1.

FIG. 3 is a block diagram schematically illustrating an example processor that can implement an instruction for performing modular multiplication.

FIG. 4 is a block diagram schematically illustrating an example state of a processor before execution of a modular multiplication instruction.

FIG. 5 is a is a block diagram schematically illustrating an example state of a processor after execution of a modular multiplication instruction.

FIG. 6 is a is a block diagram schematically illustrating another example state of a processor after execution of a modular multiplication instruction.

In the drawings, like reference symbols may indicate like and/or similar components (elements, structures, etc.) in different views. The drawings generally illustrate, by way of example, but not by way of limitation, various implementations, and aspects of those implementations discussed in the present disclosure. Reference symbols shown in one drawing may not be repeated for the same, and/or similar elements in related views. Reference symbols that are repeated in multiple drawings may not be specifically discussed with respect to each of those drawings, but are provided for context between related views. Also, not all like elements in the drawings are specifically referenced with a reference symbol when multiple instances of an element are illustrated.

### DETAILED DESCRIPTION

Asymmetric cryptography is a cryptographic primitive that can be used for digital signing, for secure key exchange, for asymmetric encryption, etc. Current asymmetric cryptography algorithms, e.g., RSA, DSA, DH, ECDSA, EdDSA, ECDH, EdDH, are implemented using calculations performed with large integers, e.g., integer with more than 1000 bits in their digital representations.

In such cryptographic implementations (cryptosystems, cryptographic algorithms, cryptographic schemes, etc.), arithmetic operations can be performed modulo a fixed large integer, which can be referred to as a modulus. These arithmetic operations, due to the size of the integers involved, are computationally intensive, and commonly performed in dedicated hardware. Of the arithmetic operations performed in cryptography implementations, modular multiplication can be the most computationally intensive.

Modular multiplication is computationally intensive because it involves division by the modulus. In prior approaches, naive algorithms used for performing such division include trial and error, which can use complicated (e.g., hardware divider) resources and repeated calculations. For instance, a prediction can be made for a digit of a result, where the computations are then corrected if the prediction is incorrect. For at least this reason, such naive algorithms can take a significant amount of computation time and/or bandwidth. Moreover, in such approaches, either a time for performing a modular multiplication operation would be dependent on the input data, making timing attacks possible, or the time for performing a modular multiplication operation would always be worst case, e.g., by executing arithmetic calculations that are superfluous, which can prevent timing attacks at the expense of increased execution time and resources.

Some prior approaches used to improve efficiency of modular multiplication operations include the use of Montgomery multiplication. Such approaches include i) converting input data to a Montgomery domain; ii) performing computations in the Montgomery domain, where instead of division by N (a large integer modulus), division by a power of 2 is used; and iii) converting output data (e.g., result(s) of computations) back from the Montgomery domain. Unlike trial division by N, which, as noted above, can be problematic, division by a power of 2, e.g., in the Montgomery domain, is computationally fast and non-intensive, e.g., can be performed as right shift operations of a long (digital) integer. However, a disadvantage of using Montgomery multiplication is the need to switch to the Montgomery domain in the beginning and to switch back in the end, which increases processing time.

This disclosure is directed to alternative approaches for modular multiplication that can address at least some of the foregoing technical problems. For instance, in approaches described herein, one technical benefit is that data (e.g., operands, etc.) is/are not switched to and from the Montgomery domain when performing modular multiplication. Instead, in implementations for modular multiplication of long integers described herein, reduced intermediate results are permitted to be slightly larger than an associated modulus. Such approaches bypass the need for exact trial division where the result is strictly less than the modulus. Such modular multiplication approaches and associated partial modular reduction can be performed in parallel. All involved large integers (operands) are subdivided into “digits” (e.g., 16-bit, or 32-bit “digits”), and one or two extended digit×digit multipliers (e.g., hardware multipliers) can be used for standard long multiplication of the operands using a digit-by-digit approach, where “extended digit” stands for “digit+2 bits”, e.g., for 16-bit digits, 18×16 multipliers can be used. In some implementations, two multipliers are used, which can reduce the computation time. In other implementations, one multiplier is used, and an associated modular multiplier can be more compact when implemented in hardware, e.g., can be implemented using a significantly lower number of logic gates.

Implementations described herein, in addition to the foregoing technical advantages and benefits, can provide a number of other improvements over prior implementations. Briefly, with further details discussed below, the disclosed implementations can use a single, fixed set of parameters that are independent of a given modulus, which allows for fixed timing of modular multiplication operation independent of modulus value for a given number of digits. This can improve (reduce) execution time and/or prevent timing attacks, as it facilitates using a fixed number of operations for modular multiplication that is based on a number of digits of an associated modulus but is independent of a value of the modulus. Also, the implementations described herein provide for final modular reduction to be built into a modular multiplier, rather than be separately implemented or determined.

The disclosed implementations further allow for efficiently implementing modular multiplication as a command in a processor architecture, and for reducing or limiting computing resources of such implementations by allowing for coincidence between memory slots used for operands and a corresponding fully reduced modular multiplication result, as well as using shared resources for storing integer values used in performing modular multiplication calculations.

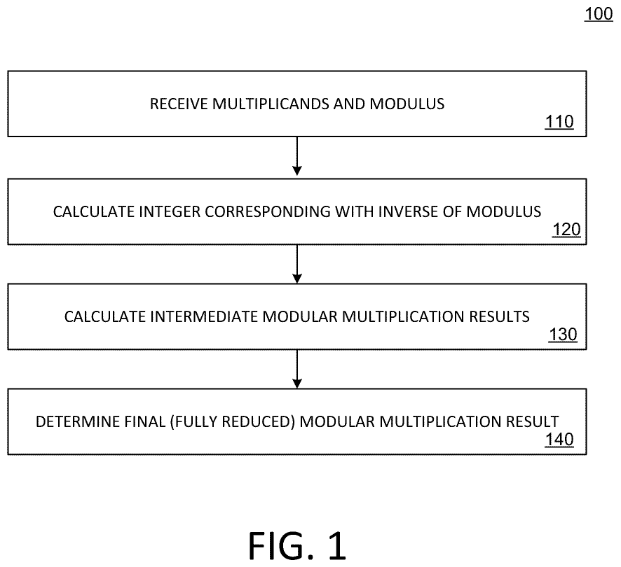

FIG. 1 is a flowchart illustrating an example method 100 for performing modular multiplication. The method 100 is a high-level representation of an approach for modular multiplication that can be implemented in a stand-alone modular multiplier (e.g., hardware modular multiplier), implemented in a cryptographic engine (e.g., cryptosystem, etc.) along with other operations such as modular addition and/or modular subtraction, and/or implemented in a general purpose processor where modular multiplication is invoked with a command (instruction) of the processor, e.g., with multiplicands and a modulus provided as operands of the instruction. In some implementations, a processor can be implemented as an application-specific integrated circuit (ASIC) based on a standard processor architecture, where the ASIC is implemented so as to perform cryptographic functions (e.g., implements a given cryptosystem, implements a stand-alone modular multiplier, etc.).

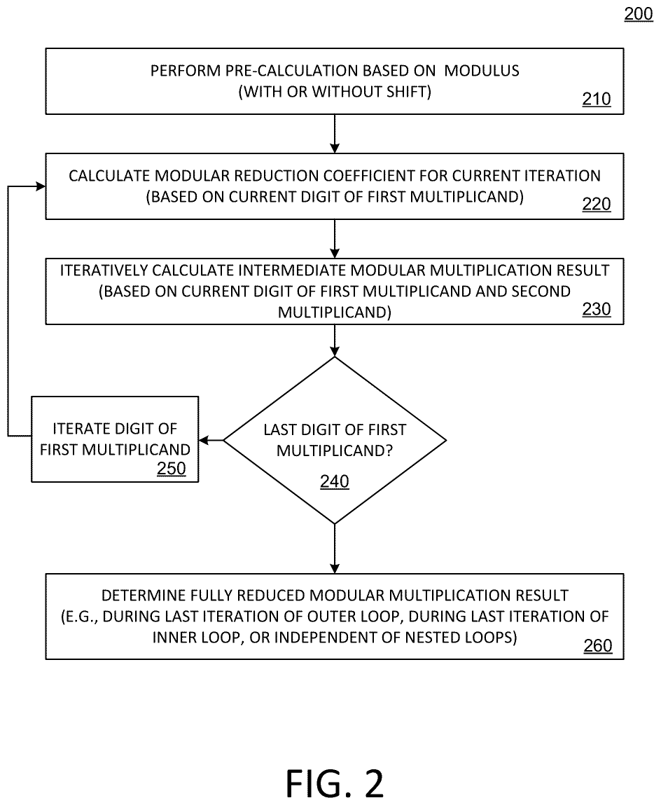

For purposes of illustration and as indicated above, the operations of FIG. 1 provide a general, high-level understanding of implementations for performing modular multiplication described herein. The discussion of FIG. 1 will be followed by a discussion of underlying mathematical processes (operations) used for performing modular multiplication, associated notation, and example calculations used for determining (obtaining, calculating, etc.) a fully reduced modular multiplication result. FIG. 2 will then be described, where FIG. 2 illustrates an example of using nested iterative loops for performing modular multiplication, e.g., in accordance with the high-level method (method 100) and the underlying mathematical processes described herein.

Referring to FIG. 1, the method 100 includes, at operation 110, receiving multiplicands and a modulus for modular multiplication. At operation 120, the method 100 includes calculating an integer corresponding with an inverse of the modulus (e.g., an inverse of a factor of two and the modulus that is an integer value). This value is referred to herein as v, which is discussed further below. Briefly, this calculation and the resulting value allows for using multiplication by v in place of division by the modulus (a large integer), which, as noted above, allows for more efficient processing, as a hardware multiplier can be used instead of a hardware divider for division by the modulus.

In some implementations, the ordering of operations 110 and 120 can be varied. For instance, in some implementations, a modulus can be provided (received), v can be calculated, the multiplicands can then be provided (received), and modular multiplication can then be performed using the multiplicands and v, such as in the examples described herein. In other words, the specific ordering of the operations 110 and 120 will depend on the particular implementation, e.g., a stand-alone modular multiplier, a modular multiplier integrated into a cryptosystem, a processor instruction, etc.

At operation 130, the method 100 includes calculating intermediate results of a modular multiplication operation. As described in further detail below, the calculations of operation 130 can be performed in nested iterative loops, e.g., a first iterative loop (outer loop) and a second iterative loop (inner loop) that is nested in the outer loop. After iteratively calculating intermediate results at operation 130, the method 100 includes, at block 140, determining a final (fully reduced) result of the modular multiplication of the multiplicands and the modulus. Examples of approaches for determining the fully reduced result are described in further detail below. Briefly, in some implementations, a fully reduced result can be determined based on calculations that are performed in a last iteration of a corresponding inner loop. In other implementations, a fully reduced result can be determined based on calculations that are performed after a last iteration of a corresponding outer loop.

As further context for the method 100, as well as other example implementations described herein, following is a discussion of the underlying mathematical operation sequences used for modular multiplication, and the notation used in the examples of this disclosure. In prior implementations, performing modular multiplication has been implemented using calculations and parameters that are dependent on a numeric value of a modulus for a particular calculation. As discussed above, such approaches have the drawbacks of allowing for timing attacks or using worst case timing for all calculations (e.g., performing superfluous calculations). The approaches described herein are implemented using a single (fixed) set of parameters and calculations that are independent of a numeric value of an associated modulus.

For instance, use of a single (fixed) set of parameters allows for performing modular multiplication such that an upper size limit of the intermediate results is also fixed. For instance, in the examples described herein, a fixed set of parameters is used that provides for a size coefficient (referred to herein as α), where a size of the intermediate results (upper size limit) is less than two times the modulus (e.g., α<2 and the upper size limit is a times the modulus). More specifically in the example implementations described herein, a fixed set of parameters (e.g., Z=4, which indirectly affects a value of α) is used, and provides for α=1.5 and a size of the intermediate results of a modular multiplication operation being less than 1.5 times the modulus. The use of Z is described in further detail below.

In the example implementations described herein, a digit size of X=16 bits is used. In some implementations, other digit sizes are possible, e.g., 32 bits, 64 bits, etc. Also in the examples provided herein, modular multiplication using 3-digit operands is described by way of example and for purposes of illustrations. In actual cryptographic implementations, operands with a larger number of digits can be used. For instance, for operands including 1024 bits, each operand (with X=16) would be 64 digits, while for operands including 2048 bits, each operand (with X=16) would be 128 digits. In such implementations, the sequence of operations would be the same, with an increased number of iterations (e.g., iterations of an outer loop and corresponding iterations of an inner loop) corresponding with a number of digits of the corresponding operands.

For purposes of discussion, specific numerical examples provided herein are to illustrate the approaches for modular multiplication describe herein. In a first numerical example operands (hex values) of a modular multiplication are as follows:
N=f70c 8e4b dc5f
A=f2e9 a315 d2f0
B=c606 536f 6053,
   where N is the modulus, A is the first multiplicand, and B is the second multiplicand.

Also, for purpose of the examples described herein a number of digits of the operands minus one is represented as γ, where the inner loop is iterated over a range of 0 to γ, or vice versa (e.g., a number of indices equal to the number of digits, or γ+1). The following relationship, with respect to the calculation of v (discussed above), applies:

$${2}^{32} = {2}^{γ X} \leq N < {2}^{( γ + 1 ) X} = {2}^{48} .$$

Based on the foregoing relationship and the fixed set of parameters, and independent of the values of A and B, v is calculated as follows:

$$v = ⌊ \frac{{2}^{( γ + 2 ) X + Z}}{N} ⌋ = ⌊ \frac{{2}^{68}}{N} ⌋ .$$

Therefore, in this numerical example, v=0010 9467.

Further in the numerical examples described herein, large numbers (integers) are represented with capital letters (e.g., A, B, N, S, D, as described herein). Furthermore, digits of the large numbers (integers) are represented with corresponding lowercase letters with an index, where the digits are numbered from the least significant digit (index 0) to the most significant digit (index γ). In the notation used herein, an expression such as b̅_̅{̅γ̅}̅b̅_̅{̅γ̅-̅1̅}̅ represents a two-digit number with a most significant digit b_{γ} and a least significant digit b_{γ-1}.

By way of background for the examples described herein, the expression F=E mod N means that E−F is divisible by N and 0≤F<N. Additionally, F=E q mod N (where q mod stands for quasi-mod) means that E−F is divisible by N and 0≤F<αN, where α>1 is a constant that is based (indirectly) on the fixed parameters used for modular multiplication in the examples described herein, e.g., Z=4, which corresponds to α=1.5. It is noted that with α=1.5 there exists, at most, two numbers F such that F=E q mod N. For purposes of this disclosure, to find E q mod N means to find either of the two possible values of F.

By way of further background, the following illustrates a modular multiplication process at a high-level of abstraction:

$$\begin{matrix}S = 0 \\ for i = γ … 0 : \\ T = {2}^{X} S + {a}_{i} B \\ S = Tq mod N \\ return S\end{matrix}$$

This example process, which is provided by way of context and for purposes of illustration, can represent implementation of nested outer and inner loops without final modular reduction to achieve a fully reduced result.

In the foregoing, in addition to the parameters defined above, S represents modular multiplication results (e.g., intermediate results) calculated during iterations of an inner and outer loop, where S is initialized to zero prior to entering the first outer loop iteration, and i is an index for digits of A.

Based on the foregoing, and given that 2^{X}aᵢ+aₐ₋₁ a̅ᵢ̅a̅ᵢ̅₋̅₁̅, it can be seen, by induction, that after iteration i, the intermediate result T equals a̅_̅{̅γ̅}̅ .̅ .̅ .̅ a̅ᵢ̅B modulo N, and S is a̅_̅{̅γ̅}̅ .̅ .̅ .̅ a̅ᵢ̅B q mod N. Therefore, after the loop is finished, S=a̅_̅{̅γ̅}̅ .̅ .̅ .̅ a̅ᵢ̅B q mod N=AB q mod N.

In ordered to calculate T q mod N, we need to find an integer q such that 0≤T−qN<αN, where q is referred herein to as a modular reduction coefficient. In the examples approaches described herein, q can be calculated in each iteration of an outer loop for use in corresponding inner loop iterations for calculating (digit-by-digit) S corresponding with a given outer loop iteration. While a first candidate for q is q=[T/N], as noted above, this is a complex calculation with large numbers (integers).

Instead q can be calculated using the fact that

$$v = ⌊ \frac{{2}^{( γ + 2 ) X + Z}}{N} ⌋ .$$

Accordingly, └T/N┘ can be replaced with:

$$q = ⌊ \frac{T v}{{2}^{( γ + 2 ) X + Z}} ⌋ \geq ⌊ T / N ⌋ ,$$

which corresponds with performing calculation in integers

$${q}^{*} = T v = ( {2}^{X} S + {a}_{i} B ) v$$

and then dropping the least significant (γ+2)X+Z bits or, in other words, dropping the least significant γ+2 digits and additionally dropping Z bits. While this is still a calculation with large integers, it replaces larger integer division with large integer multiplication, which can provide the associated benefits described herein.

To simplify the foregoing expression, it is noted that that the result of q is only slightly larger than one digit. For instance, S<αN, B<N and aᵢ<2^{X}, so 2^{X}S+aᵢB<2^{X}αN+2^{X}N=(α+1)2^{X}N, and q<(α+1)2^{X}<2^{X+2} for α=1.5. Therefore, the calculation of (2^{X}S+aᵢB)v can be performed at each iteration where only two most significant digits (i.e., 2X bits) of the intermediate results are retained, which can be mathematically proven to provide results accurate enough to ensure that 0≤T−qN<αN.

Accordingly, starting with the large integers S and B and limiting them to the two most significant digits, in the expression:

$${q}^{*} = ( {2}^{X} S + {a}_{i} B ) v$$

the expression:

2^{X}S+aᵢB

can be replaced with:

$${2}^{( γ - 1 ) X} ( {2}^{X} \overline{{s}_{γ} {s}_{γ - 1}} + {a}_{i} \overline{{b}_{γ} {b}_{γ - 1}} ) .$$

To calculate the resulting expression, because multiplications by powers of 2 are implemented as data shifts, we only need to perform two (γ×γ)-bit multiplications—aᵢ×b_{γ} and aᵢ×b_{γ-1}, and corresponding shifts and additions. The upper limit for possible values of 2^{X}s̅_̅{̅γ̅}̅s̅_̅{̅γ̅-̅1̅}̅+aᵢb̅_̅{̅γ̅}̅b̅_̅{̅γ̅-̅1̅}̅ is slightly more than three digits. For instance:

$$\begin{matrix}{2}^{X} \overline{{s}_{γ} {s}_{γ - 1}} < {2}^{X} α \overline{{n}_{γ} {n}_{γ - 1}} < α \cdot {2}^{3 X} \\ {a}_{i} \overline{{b}_{γ} {b}_{γ - 1}} < {2}^{X} \cdot {2}^{2 X} = {2}^{3 X} \\ {2}^{X} \overline{{s}_{γ} {s}_{γ - 1}} + {a}_{i} \overline{{b}_{γ} {b}_{γ - 1}} < α \cdot {2}^{3 X} + {2}^{3 X} = ( α + 1 ) {2}^{3 X} < {2}^{3 X + 2}\end{matrix}$$

In the foregoing expressions, dropping the least significant digit from 2^{X}s̅_̅{̅γ̅}̅s̅_̅{̅γ̅-̅1̅}̅+aᵢb̅_̅{̅γ̅}̅b̅_̅{̅γ̅-̅1̅}̅, obtains a (2X+2)-bit number which is referred to herein as t=t̅₁̅t̅₀̅, where t₁ is an extended (X+2)-bit digit rather than a standard X-bit digit. Accordingly, the next approximate replacement of:

$${q}^{*} = {2}^{( γ - 1 ) X} ( {2}^{X} \overline{{S}_{γ} {S}_{γ - 1}} + {a}_{i} \overline{{b}_{γ} {b}_{γ - 1}} )$$

can be:

q*=2^{γX}tv.

In the implementations described herein, the fixed parameters guarantee that, for a given digit size X v=v̅₁̅v̅₀̅ is a two-digit number. To calculate tv, four multiplications operations can be used, two of which are ((γ+2)×γ)-bit, and two are (γ×γ)-bit. However, since only the X+2 most significant bits of the result are used, which is less than two digits, the calculation of t₀v₀ can be omitted, and only three products can be calculated, e.g., t₁v₁, t₁v₀, t_{σ}v₁, and several shifts and additions can be performed.

Based on the foregoing:

q*=2^{γX}tv

can be approximately replaced with:

$${q}^{*} = {2}^{( γ + 1 ) X} ( {2}^{X} {t}_{1} {v}_{1} + {t}_{1} {v}_{0} + {t}_{0} {v}_{1} )$$

### And:

$$q = ⌊ \frac{Tv}{{2}^{( γ + 2 ) X + Z}} ⌋ = ⌊ \frac{{q}^{*}}{{2}^{( γ + 2 ) X + Z}} ⌋$$

can be replaced with:

$$q = ⌊ \frac{{2}^{( γ + 1 ) X} ( {2}^{X} {t}_{1} {v}_{1} + {t}_{1} {v}_{0} + {t}_{0} {v}_{1} )}{{2}^{( γ + 2 ) X + Z}} ⌋ = ⌊ \frac{{2}^{X} {t}_{1} {v}_{1} + {t}_{1} {v}_{0} + {t}_{0} {v}_{1}}{{2}^{X + Z}} ⌋ .$$

In view of the foregoing discussion regarding calculation of t and q, the high-level modular multiplication process provided above can now be expressed (still without final reduction) as follows:

$$S = 0$$

$$for$$

$$i = γ…0 :$$

$$\overline{{t}_{1} {t}_{0}} = ⌊ ( {2}^{X} \overline{{s}_{γ} {s}_{γ - 1}} + {a}_{i} \overline{{b}_{γ} {b}_{γ - 1}} ) / {2}^{X} ⌋ ( 2 multiplications - {a}_{i} \times {b}_{γ} and {a}_{i} \times {b}_{γ - 1} )$$

$$q = ⌊ ( {2}^{X} {t}_{1} {v}_{1} + {t}_{1} {v}_{0} + {t}_{0} {v}_{1} ) / {2}^{X + Z} ⌋ ( 3 multiplications - {t}_{1} \times {v}_{1} , {t}_{1} \times {v}_{0} , {t}_{0} \times {v}_{1} )$$

$$S = {2}^{X} S + {a}_{i} B - qN ( the inner loop with γ + 1 iterations and 2 multiplications at each iteration , e . g . , at iteration j - {a}_{i} \times {b}_{j} and q \times {n}_{j} )$$

$$return S .$$

FIG. 2 is a flowchart illustrating another example method 200 for performing modular multiplication, which can be an implementation of the method of FIG. 1 using the relationships and expressions discussed above, e.g., using v, t and q to perform modular multiplication to calculate AB mod N. As shown in FIG. 2, the method 200 includes, at operation 210, performing a pre-calculation of v based on a modulus N. Depending on the value of the modulus N, as is described further below, v can be calculated based on an actual value of the modulus N (e.g., if the most significant half digit of N is greater than zero), or the value of the modulus N left-shifted left by one-half digit, or eight bits in this example (e.g., if the most significant half digit of N is zero). This approach ensures that the value of v is large enough for corresponding calculations to have sufficient precision to guarantee that the intermediate results are less than the upper size limit (e.g., αN), and also ensures that v is not too large, so that it fits in two digits. If the modulus N is left-shifted, at least one of the multiplicands A or B will also be shifted, e.g., so that the corresponding calculations of digits of A times B will be properly aligned (bit-aligned) with the shifted modulus N.

In some implementations, such as processor instruction implementations, operands are all stored shifted, or all stored unshifted (e.g., depending on the most-significant half-digit of the modulus N). A bit (referred to herein as shift) can be used to indicate whether or not the operands are shifted. If shift indicates that the operands are shifted, the shift of one of the multiplicands A or B will be ignored, again so that results of corresponding calculations of digits of A times B will be properly aligned with the shifted modulus N.

After the calculation of v at operation 210, the method 200 proceeds to a first iteration of an outer loop (first iterative loop) at operation 220. For the first iteration of the outer loop, an associated index i corresponding with digits of A is set to γ, e.g., the first iteration of the outer loop, in combination execution of a corresponding inner loop (nested, second iterative loop) will produce an intermediate result S based on the digit a_{γ} times B.

At operation 220, a respective modular reduction coefficient q for a current digit (e.g., ay in the first iteration) is calculated in each iteration of the outer loop. The calculated value of q is then used in the inner loop (operation 230) to iteratively calculate an intermediate result S based on the current digit of A and all the digits of B (from a least significant digit b₀ to a most significant digit b_{γ}).

For iterations of the outer loop after the first iteration, the inner loop of operation 230 calculates and a respective intermediate result S based on a current digit a of A, all digits of B (from a least significant digit b₀ to a most significant digit b_{γ}), and a value of S calculated in the immediately preceding iteration of the outer loop (and its associated inner loop). After calculating a current intermediate result S at operation 230, the method proceeds to operation 240. If the index i is greater than zero (additional digits of A remain), the method 200 proceed to operation 250 and the index i is iterated (e.g., decremented) and the method 200 returns to operation 220 to begin the next iteration of the outer loop (including an associated execution of operation 230 (the inner loop).

If, however, the index i is zero, indicating that the outer loop has iterated over all digits of A, the method 200 moves to operation 260, where a final (fully reduced) result of the modular multiplication is determined. In some implementations, operation 260 can be included in a last instance of the inner loop (operation 230), where the inner loop can include conditional operations that are only performed during an inner loop associated with a last outer loop iteration. In some implementations, operation 260 can be performed after completing a final iteration of the outer loop (e.g., for index i=0).

The following discussion describes numerical examples of performing modular multiplication using the approaches described herein. In the first numerical example, iterations of an outer loop (with three-digit operands) are illustrated. As noted above, each iteration of the outer loop, in this example, includes calculation of q for a current digit aᵢ of A, with calculation of a corresponding intermediate result S for that outer loop iteration being calculated by a corresponding inner loop. In the first numerical example, the inner loop is illustrated as a summarized calculation of S.

Following the numerical example for iterations of the outer loop, a discussion of approaches for determining a final (fully reduced) modular multiplication result is provided. After the discussion of final reduction approaches, numerical examples of operations (calculations) of and inner loop for a final iteration of an associated outer loop are shown, first in summary form and then for each iteration of the inner loop. Examples of the two approaches for determining a final (fully reduced) modular multiplication result discussed above are then provided (e.g., determining the fully reduced result in last inner loop iteration, and determining the fully reduced result after a last iteration of the outer loop).

### Numerical Example of Outer Loop Iterations

As in the previous example, N, v, A and B in this numerical example are:
N=f70c 8e4b dc5f
v=0010 9467
A=f2e9 a315 d2f0
B=c606 536f 6053,
   and the initial value of S=0 0000 0000 0000.

In the first iteration of the outer loop, the modular reduction coefficient q for digit a₂ (f2e9) of A is calculated by first calculating t, as described above, and then q is calculated by multiplying t times v.

First, t for the first iteration of the outer loop (for digit a₂) is calculated as follows, e.g., according to the equations and relationships discussed above:

$${a}_{2} {b}_{2} = f 2 e 9 \times c 606 = \begin{matrix}bbe 5 & e 776\end{matrix}$$

$${a}_{2} {b}_{1} = f 2 e 9 \times 536 f = \begin{matrix}4 f 2 a & de 07\end{matrix}$$

$$\begin{matrix}0 & 0000 & 0000 & 0000 \\ & bbe 5 & e 776 & 0000 \\ & 0000 & 4 f 2 a & de 07 \\ 0 & bbe 6 & 36 a 0 & de 07\end{matrix}$$

$$t = \begin{matrix}0 & bbe 6 & 36 a 0\end{matrix}$$

Next, q for the first iteration of the outer loop (for digit a₂) is calculated from t and v as follows, e.g., according to the equations and relationships discussed above:

$${t}_{1} {v}_{1} = \begin{matrix}0 & bbe 6 \times \end{matrix} 0010 = \begin{matrix}0 & 000 b & be 60\end{matrix}$$

$${t}_{1} {v}_{0} = \begin{matrix}0 & bbe 6 \times \end{matrix} 9467 = \begin{matrix}0 & 6 cec & 918 a\end{matrix}$$

$${t}_{0} {v}_{1} = \begin{matrix} & 36 a 0 \times \end{matrix} 0010 = \begin{matrix} & 0003 & 6 a 00\end{matrix}$$

$$\begin{matrix}0 & 000 b & be 60 & 0000 \\ & 0 & 6 cec & 918 a \\ & & 0003 & 6 a 00 \\ 0 & 000 c & 2 b 4 f & fb 8 a\end{matrix}$$

$$q = \begin{matrix}0 & 000 c & 2 b 4 f & fb 8 a /\end{matrix} {2}^{20} = \begin{matrix}0 & c 2 b 4\end{matrix}$$

Next, S for the current (first) iteration of the nested outer and inner loops is calculated by the inner loop. A summary of this calculation of S is follows:

$$\begin{matrix}S = \begin{matrix}0 & 0000 & 0000 & 0000 & 0000\end{matrix} // {2}^{X} S \\ + \begin{matrix} & bbe 6 & 36 a 1 & 396 d & 218 b // {a}_{2} B\end{matrix} \\ - \begin{matrix}0 & bbe 5 & 38 a 9 & 8 a 56 & f 0 cc\end{matrix} // qN \\ = \begin{matrix} & 0 & fdf 7 & af 16 & 30 bf ,\end{matrix}\end{matrix}$$

where S>N, i.e., S is not fully reduced in this iteration.

In the next (second) iteration of the outer loop, the modular reduction coefficient q for digit a₁ (a315) of A is calculated by first calculating t, as described above, and then q is calculated by multiplying t times v.

First, t for this (second) iteration of the outer loop (for digit a₁) is calculated as follows, e.g., according to the equations and relationships discussed above:

$${a}_{1} {b}_{2} = a 315 \times c 606 = \begin{matrix}7 e 26 & 107 e\end{matrix}$$

$${a}_{1} {b}_{1} = a 315 \times 536 f = \begin{matrix}3526 & 851 b\end{matrix}$$

$$\begin{matrix}0 & fdf 7 & af 16 & 0000 \\ & 7 e 26 & 107 e & 0000 \\ & 0000 & 3526 & 851 b \\ 1 & 7 c 1 d & f 4 ba & 851 b\end{matrix}$$

$$t = \begin{matrix}1 & 7 c 1 d & f 4 ba\end{matrix}$$

Next, q for this (second) iteration of the outer loop (for digit a₁) is calculated from t and v as follows, e.g., according to the equations and relationships discussed above:

$${t}_{1} {v}_{1} = \begin{matrix}1 & 7 c 1 d \times 0010\end{matrix} = \begin{matrix}0 & 0017 & c 1 d 0\end{matrix}$$

$${t}_{1} {v}_{0} = \begin{matrix}1 & 7 c 1 d \times 9467\end{matrix} = \begin{matrix}0 & dc 59 & b 3 ab\end{matrix}$$

$${t}_{0} {v}_{1} = \begin{matrix} & f 4 ba \times 0010\end{matrix} = \begin{matrix} & 000 f & 4 ba 0\end{matrix}$$

$$\begin{matrix}0 & 0017 & c 1 d 0 & 0000 \\ & 0 & dc 59 & b 3 ab \\ & & 000 f & 4 ba 0 \\ 0 & 0018 & 9 e 38 & ff 4 b\end{matrix}$$

$$q = \begin{matrix}0 & 0018 & 9 e 38 & ff 4 b /\end{matrix} {2}^{20} = \begin{matrix}1 & 89 e 3\end{matrix}$$

Next, S for the current (second) iteration of the nested loops is calculated by the inner loop. A summary of this calculation of S is follows:

$$\begin{matrix}S = \begin{matrix}0 & fdf 7 & af 16 & 30 bf & 0000\end{matrix} // {2}^{X} S \\ + \begin{matrix} & 7 e 26 & 45 a 4 & c 277 & bfcf // {a}_{1} B\end{matrix} \\ - \begin{matrix}1 & 7 c 1 d & 5694 & a 292 & 3 f 3 d\end{matrix} // qN \\ = \begin{matrix} & 0 & 9 e 26 & 50 a 4 & 8092\end{matrix}\end{matrix}$$

where S<N, i.e., S is fully reduced in this iteration.

In the next (third or, in this example, final) iteration of the outer loop, the modular reduction coefficient q for digit a₀ (a315) of A is calculated by first calculating t, as described above, and then q is calculated by multiplying t times v.

First, t for this (final) iteration of the outer loop (for digit a₀) is calculated as follows, e.g., according to the equations and relationships discussed above:

$${a}_{0} {b}_{2} = d 2 f 0 \times c 606 = \begin{matrix}a 32 a & 91 a 0\end{matrix}$$

$${a}_{0} {b}_{1} = d 2 f 0 \times 536 f = \begin{matrix}44 bf & 4610\end{matrix}$$

$$\begin{matrix}0 & 9 e 26 & 50 a 4 & 0000 \\ & a 32 a & 91 a 0 & 0000 \\ & 0000 & 44 bf & 4610 \\ 1 & 4151 & 2703 & 4610\end{matrix}$$

$$t = \begin{matrix}1 & 4151 & 2703\end{matrix}$$

Next, q for the (final) iteration of the outer loop (for digit a₀) is calculated from t and v as follows, e.g., according to the equations and relationships discussed above:

$${t}_{1} {v}_{1} = \begin{matrix}1 & 4151 \times 0010\end{matrix} = \begin{matrix}0 & 0014 & 1510\end{matrix}$$

$${t}_{1} {v}_{0} = \begin{matrix}1 & 4151 \times 9467\end{matrix} = \begin{matrix}0 & ba 44 & 1 b 97\end{matrix}$$

$${t}_{0} {v}_{1} = \begin{matrix} & 2703 \times 0010\end{matrix} = \begin{matrix}0002 & 7030\end{matrix}$$

$$\begin{matrix}0 & 0014 & 1510 & 0000 \\ & 0 & ba 44 & 1 b 97 \\ & & 0002 & 7030 \\ 0 & 0014 & cf 56 & 8 bc 7\end{matrix}$$

$$q = \begin{matrix}0 & 0014 & cf 56 & 8 bc 7 /\end{matrix} {2}^{20} = \begin{matrix}1 & 4 cf 5\end{matrix}$$

Next, S for the current (final) iteration of the nested loops is calculated by the inner loop. A summary of this calculation of S is follows:

$$\begin{matrix}S = \begin{matrix}0 & 9 e 26 & 50 a 4 & 8092 & 0000\end{matrix} // {2}^{X} S \\ + \begin{matrix} & a 32 a & d 65 f & 956 e & 63 d 0 // {a}_{0} B\end{matrix} \\ - \begin{matrix}1 & 4150 & b 78 e & 9065 & 1 aeb\end{matrix} // qN \\ = \begin{matrix} & 0 & 6 f 75 & 0859 b & 48 e 5\end{matrix}\end{matrix}$$

where S<N, i.e., S is fully reduced in this iteration and is the final result in this example. If, however, is S≥N, additional calculations and/or operations can be performed to achieve or determine the final (fully reduced) modular multiplication result.

When S calculated during a last iteration of the nested loops is greater than N, in order to achieve a final (fully reduced) modular multiplication result (e.g., for AB mod N), additional operations can be performed. In some implementations, as discussed above, these operations can be performed (conditionally performed based on a value of index i) in the inner loop corresponding with a last iteration of the outer loop (e.g., when i=0), or can be performed after a last iteration of the outer loop.

In each of these approaches, a final (fully reduced) result is determined by calculating a difference D between a value of S calculated in inner loop during a final iteration of the outer loop (e.g., for digit a₀ in the example above) and the associated modulus N. As S is guaranteed to the less than αN (e.g., 1.5N in the examples described herein), the difference D is guaranteed, if positive, to be less than N (and then D the fully reduced result). Alternatively, if D is negative, S is guaranteed to be less than N (and then S the fully reduced result). In some implementations, calculations of S and D during a last iteration of the nested loops (i=0) can be performed in parallel, with an additional subtraction of nⱼ at iteration j of the inner loop, where the index j is an index for digits of B during the inner loop calculation S. In the examples described herein j is indexed from 0 to γ for each iteration of the inner loop.

Adding operations for determining a fully reduced modular multiplication result to the previous modular multiplication process can be implemented as follows, where the operations for determining the final (fully reduced) result, which, as indicated above, can be performed in the last iteration of the inner loop (during a last iteration of the outer loop) are specifically indicated:

$$S = 0$$

$$for$$

$$i = γ…0 :$$

$$\overline{{t}_{1} {t}_{0}} = ⌊ ( {2}^{X} \overline{{s}_{γ} {s}_{γ - 1}} + {a}_{i} \overline{{b}_{γ} {b}_{γ - 1}} ) / {2}^{X} ⌋ ( 2 multiplications - {a}_{i} \times {b}_{γ} and {a}_{i} \times {b}_{γ - 1} )$$

$$q = ⌊ ( {2}^{X} {t}_{1} {v}_{1} + {t}_{1} {v}_{0} + {t}_{0} {v}_{1} ) / {2}^{X + Z} ⌋ ( 3 multiplications - {t}_{1} \times {v}_{1} , {t}_{1} \times {v}_{0} , {t}_{0} \times {v}_{1} )$$

$$S = {2}^{X} S + {a}_{i} B - qN ( the inner loop with γ + 1 iterations and 2 multiplications at each iteration , e . g . , at iteration j - {a}_{i} \times {b}_{j} and q \times {n}_{j} )$$

$$// Final reduction operations$$

$$if i = 0$$

$$D = S - N$$

$$if D > 0 :$$

$$return D$$

$$else :$$

$$return S$$

This approach for performing final reduction to determine a final (fully reduced) modular multiplication result prevents the final result from including more digits than the modulus, which can be inefficient, e.g., in hardware implementations. For instance, without performing a final reduction as described above, the result provided (e.g., a final intermediate result S) can be one digit longer than the modulus N. As an example, if a modulus N is 2,048 bits long (which is a typical size for RSA), memory slots with an additional digit (e.g., 2,064 bits long for X=16) would be needed to accommodate all possible values of a non-fully reduced result. With the final reduction approach described above, memory slots of a same size as a memory slot used for a corresponding modulus N are sufficient.

Further to the foregoing example of outer loop iterations, the following discussion is directed to numerical examples of inner loop iterations for the last iteration of the outer loop described above, e.g., for digit a₀. That is, the following examples illustrate step-by-step execution of the inner loop for a corresponding last iteration of the outer loop.

Based on the last iteration of the outer loop in the example described above, inputs for the inner loop corresponding with the last outer loop are:
N=f70c 8e4b dc5f
B=c606 536f 6053
a₀=d2f0
S=0 9e26 50a4 8092
q=1 4cf5

In a first example, final reduction is performed in the inner loop associated with a last outer loop iteration. Here, in the inner loop, S=2¹⁶S₋₁+aᵢB−qN is calculated and, in parallel, D=2¹⁶S₋₁+aᵢB−qN−N is calculated, where the intermediate result before the inner loop is represented as S₋₁, the final intermediate result calculated by the inner loop of the last outer loop iteration is represented as S.

First, a summary of each of the arithmetical operations of the inner loop, e.g., two multiplications, addition and subtraction separately. Following this summary, the arithmetical operations are shown step-by-step, e.g., to illustrate how they can be executed in parallel.

In the summary of this example, a₀ is multiplied times B, which produces a value a₀B as shown below:

$$B = \begin{matrix}c 606 & 536 f & 6053\end{matrix} \times {a}_{0} = d 2 f 0$$

$$\begin{matrix}4 f 5 e & 63 d 0\end{matrix} + \begin{matrix}44 bf & 4610\end{matrix} + \begin{matrix}a 32 a & 91 a 0\end{matrix}$$

$${a}_{0} B = \begin{matrix}a 32 a & d 65 f & 956 e & 63 d 0\end{matrix}$$

Then q times N is calculated to obtain qN as follows:

$$N = \begin{matrix}f 70 c & 8 e 4 b & dc 5 f\end{matrix} \times q = \begin{matrix}1 & 4 cf 5\end{matrix}$$

$$\begin{matrix}1 & 1 e 9 e & 1 aeb\end{matrix} + \begin{matrix}0 & b 911 & 71 c 7\end{matrix} + \begin{matrix}1 & 414 f & fe 7 c\end{matrix}$$

$$qN = \begin{matrix}1 & 4150 & b 78 e & 9065 & 1 aeb\end{matrix}$$

Then S and D are calculated from S₋₁, a₀B and qN as follows:

$${2}^{16} {S}_{- 1} = \begin{matrix}0 & 9 e 26 & 50 a 4 & 8092 & 0000\end{matrix} + {a}_{0} B = \begin{matrix}a 32 a & d 65 f & 956 e & 63 d 0\end{matrix}$$

$$\begin{matrix}1 & 4151 & 2704 & 1600 & 63 d 0\end{matrix} - qN = \begin{matrix}1 & 4150 & b 78 e & 9065 & 1 aeb\end{matrix}$$

$$S = \begin{matrix}0 & 6 f 75 & 859 b & 48 e 5\end{matrix} - N = \begin{matrix}f 70 c & 8 e 4 b & dc 5 f\end{matrix}$$

$$D = \begin{matrix}( - 1 ) & 7868 & f 74 f & 6 c 86\end{matrix}$$

In this example, because the subtraction of N from S resulted in a borrow from the most significant bit (i.e., the result S−N, or D is negative). Accordingly, the final (fully reduced) result of modular multiplication (e.g., AB mod N) in this case is S rather than D.

Further to the foregoing example of calculations in an inner loop during a last iteration of an outer loop (e.g., final reduction performed in the inner loop), the following is a step-by-step illustration of the calculations summarized above. In this example, the last (in this case the third) inner loop for a last outer loop iteration is different from the inner loops for all other (previous) iterations of the outer loop. Specifically, in this example, the inner loop of the last iteration of the outer loop, in addition to the determining the digits of the final intermediate result S, the digits of D are calculated in parallel (e.g., one digit of the final S and one digit of D in each modified inner loop iteration).

Based on the previous example, the inputs for the first iteration of the inner loop (for the last outer loop iteration) are:
b₀=6053
a₀=d2f0
n₀=dc5f
q=1 4cf5
(No digits of S are used in this iteration, as S is left-shifted by one digit.)

In this first inner loop iteration (1) a₀, the least-significant digit of A for the last outer loop iteration, is multiplied by b₀ the least-significant digit of B; (2) no, the least significant digit of N, is multiplied by q, as provided from the outer loop; and (3) so, the least significant digit of S and do, the least significant digit of D are calculated in parallel, as shown in following:

$${b}_{0} = 6053 \times {a}_{0} = d 2 f 0$$

$$4 f 5 e \qquad 63 d 0$$

$${n}_{0} = dc 5 f \times q = \begin{matrix}1 & 4 cf 5\end{matrix}$$

$$1 \qquad 1 e 9 e \qquad 1 aeb$$

$$\begin{matrix}4 f 5 e & 63 d 0 & ( {a}_{0} {b}_{0} )\end{matrix} - \begin{matrix}1 & 1 e 9 e & 1 aeb & ( {qn}_{0} )\end{matrix}$$

$$( - 1 ) \qquad 30 c 0 \qquad 48 e 5$$

$$48 e 5 - {n}_{0} = dc 5 f$$

$$( - 1 ) \qquad 6 c 86$$

Accordingly, the outputs from this first iteration of the inner loop are:
s₀=48e5
d₀=6c86
With carry in the calculation of S=(−1) 30c0
With carry in the calculation of D=(−1)

Based on the previous example and the outputs from the first inner loop iteration, the inputs for the next (second) iteration of the inner loop (for the last outer loop iteration) are:
s₀=8092
b₁=536f
a₀=d2f0
n₁=8e4b
q=1 4cf5
With carry in the calculation of S=(−1) 30c0
With carry in the calculation of D=(−1)

In this second inner loop iteration (1) a₀, the least-significant digit of A for the last outer loop iteration, is multiplied by b₁ the next most-significant digit of B after b₀; (2) n₁, the next most-significant digit of N after no, is multiplied by q, as provided from the outer loop; and (3) s₁ of S and d₁ of D are calculated of D are calculated in parallel, which includes applying the carries from the first inner loop iteration, as shown by the following:

$${b}_{1} = 536 f \times {a}_{0} = d 2 f 0$$

$$44 bf \qquad 4610$$

$${n}_{1} = 8 e 4 b \times q = \begin{matrix}1 & 4 cf 5\end{matrix}$$

$$0 \qquad b 911 \qquad 71 c 7$$

$$\begin{matrix}44 bf & 4610 & ( {a}_{0} {b}_{1} )\end{matrix} + \begin{matrix}( - 1 ) & 30 c 0 & ( carry )\end{matrix}$$

$$44 be \qquad 76 d 0 + \begin{matrix}8092 & ( {s}_{0} )\end{matrix}$$

$$\begin{matrix}44 be & f 762\end{matrix} - \begin{matrix}0 & b 911 & 71 c 7 & ( {qn}_{1} )\end{matrix}$$

$$( - 1 ) \qquad 8 bad \qquad 859 b$$

$$859 b - {n}_{1} = 8 e 4 b$$

$$\begin{matrix}( - 1 ) & f 750\end{matrix} + \begin{matrix}( - 1 ) & ( carry )\end{matrix}$$

$$( - 1 ) \qquad f 74 f$$

Accordingly, the outputs from this second iteration of the inner loop are:
s₁=859b
d₁=f74f
With carry in the calculation of S=(−1) 8bad
With carry in the calculation of D=(−1)

Based on the previous example and the outputs from the second inner loop iteration, the inputs for the next (last in this example) iteration of the inner loop (for the last outer loop iteration) are:
s_{2,1}=9e26 50a4
b₂=c606
a₀=d2f0
n₂=f70c
q=1 4cf5
With carry in the calculation of S=(−1) 8bad
With carry in the calculation of D=(−1)

In this last inner loop iteration: (1) a₀, the least-significant digit of A for the last outer loop iteration, is multiplied by b₂ the most-significant digit of B; (2) n₂, the most-significant digit of N, is multiplied by q, as provided from the outer loop; (4) s₁ of S and _{d1} of D are calculated in parallel; and (4) the final (fully reduced) result is determined based on whether or not d₂, the most significant digit of D indicates that D is negative (e.g., if D<0, S is the final result, and if D≥0, D is the final result). These calculations includes applying the carries from the second inner loop iteration, and are shown by the following:

$${b}_{2} = c 606 \times {a}_{0} = d 2 f 0$$

$$a 32 a \qquad 91 a 0$$

$${n}_{2} = f 70 c \times q = \begin{matrix}1 & 4 cf 5\end{matrix}$$

$$1 \qquad 414 f \qquad fe 7 c$$

$$\begin{matrix}a 32 a & 91 a 0 & ( {a}_{0} {b}_{2} )\end{matrix} + \begin{matrix}( - 1 ) & 8 bad & ( carry )\end{matrix}$$

$$\begin{matrix}a 32 a & 1 d 4 d\end{matrix} + \begin{matrix}9 e 26 & 50 a 4 & ( {s}_{1} )\end{matrix}$$

$$\begin{matrix}1 & 4150 & 6 df 1\end{matrix} - \begin{matrix}1 & 414 f & fe 7 c & ( {qn}_{2} )\end{matrix}$$

$$0 \qquad 6 f 75$$

$$6 f 75 - {n}_{2} = f 70 c$$

$$\begin{matrix}( - 1 ) & 7869\end{matrix} + \begin{matrix}( - 1 ) & ( carry )\end{matrix}$$

$$( - 1 ) \qquad 7868$$

Accordingly, the outputs from this third (final) iteration of the inner loop are:
s2=0 6f75
d₂=(−1) 7868
   and we can see from d₂ that D is negative, and therefore S is the correct fully reduced result.

An advantage of this example approach is improved performance, no additional time (clock cycles) is used for the calculation of D. However, as compared with the following example (where the final result is determined after the last outer loop iteration, in the present example, five digits, rather than 4 digits, are read or written at each iteration of the inner loop (e.g., reading digits of S₋₁, N, and B, and writing digits of S and D) which can require, depending on the particular implementation, increasing a number of available read/write ports, a wider bus, and/or more data buffering.

As noted above, in some implementations, a final fully reduced result can be determined after a last iteration of an outer loop (first iterative loop is completed). In an example, the calculations in the example above can be performed, with the determination of the digits of D being omitted. That is, only the digits of S are calculated in respective iterations of the nested loops and all iterations of the outer loop are the same for their respective digits of A. Instead, an additional subtraction can be performed after the last iteration of the outer loop (and all digits of S are determined) to calculate D and determine, based on the value of D, which of S or D is the final (fully reduced) result of the modular multiplication.

The following is a numerical example of step-by-step operations of iteration of a subtraction loop for calculating D (from S and N) and determining a fully reduced (final) result of AB mod N for this example. Accordingly, the inputs to a subtraction loop in this example are:
S=0 6f75 859b 48e5
N=f70c 8e4b dc5f
   and the inputs to a first iteration of the subtraction loop are:
s₀=48e5
n₀=dc5f

In a first iteration of the subtraction loop, a difference of so and no can be calculated as follows:

$$48 e 5 - dc 5 f$$

$$( - 1 ) \qquad 6 c 86$$

where the outputs of the first iteration of the subtraction loop are as follows:
d₀=6c86
Carry=(−1)

Based on the foregoing, the inputs to the next (second) iteration of the subtraction loop are:
s₁=859b
n₁=8e4b
Carry=(−1)
   and a difference of a difference of s₁ and n₁ (including the Carry) can be calculated as follows:

$$859 b - 8 e 4 b$$

$$\begin{matrix}( - 1 ) & f 750\end{matrix} + ( - 1 )$$

$$( - 1 ) \qquad f 74 f$$

where the outputs of the second iteration of the subtraction loop are as follows:
d₁=f74f
Carry=(−1)

Based on the foregoing, the inputs to the next (third and final) iteration of the subtraction loop are:
s₂=0 6f75
n₂=f70c
Carry=(−1)
   and a difference of a difference of s₂ and n₂ (including the Carry) can be calculated as follows:

$$6 f 75 - f 70 c$$

$$\begin{matrix}( - 1 ) & 7869\end{matrix} + ( - 1 )$$

$$( - 1 ) \qquad 7868$$

where the output of the third iteration of the subtraction loop is as follows:
d₂=(−1) 7868
   and it can be determined that D is negative and, therefore, S is the correct, fully reduced (final) modular multiplication result (e.g., AB mod N).

An advantage of implementations that include such a subtraction loop, as compared to implementations that determine digits of D in parallel with digits of S in the inner loop of a last outer loop iteration, is that only four digits are read/written at each iteration of the inner loop, which is the same in all other iterations of the outer loop, allowing for fewer read/write ports to be used in, e.g., hardware implementations (such as processors and/or and ASIC device).

While not specifically described, in some implementations subtractions can be replaced with additions, which handling carries but not borrows. In the examples described herein, subtractions are used for purposes of clarity and illustration. In some implementations, a data bus (e.g., a RAM bus) used to write/read digits in iterations of the nest loops can be configured to allow for writing/reading a number of digits corresponding the largest number of digits that are written/read during performance of the nested iterative loop. For instance, a data bus configured to write/read four or five digits in parallel, which allows for all digits of a given loop iteration to be written/read in a single clock (or instruction) cycle.

As was discussed above, in prior approaches different sets of parameters are used for modular multiplication, e.g., depending on a position of a most significant bit of the modulus N of its most significant digit. In the implementations described herein, to facilitate using a single set of parameters, shifting of operands is used. For instance, presuming even sized digits, if a most significant bit of the modulus is in a least significant half of the most significant digit (the most significant half-digit of the modulus is zero), then all the operands, A, B and N, are left-shifted by a half-digit (e.g., stored left-shifted. Additionally, e.g., in hardware and/or processor implementations, a bit shift can be stored in a register, where shift indicates whether the operands are not shifted left (as in the previous numerical examples), or are left-shifted left (as in the numerical example below). In cases where the operands are left-shifted, multiplication of the digits of A can be read as if they were not left-shifted, so that the result of A times B remains left-shifted by a half-digit rather than by a whole digit.

The following is a numerical example that involved left-shifting of the operations A, B and N for a modular multiplication operation for AB mod N, where the most-significant half digit of N is zero. In this example, the initial inputs (operands) are:
N_orig=0001 5a43 3ed0
A_orig=0001 44f3 5895
B_orig=0000 b8cb 751b
   and since the most-significant half-digit of N is zero, the operands are replaced with, preferably prior to the execution of the modular multiplication instruction, or are left-shifted one-half digit to provide:
N=015a 433e d000
A=0144 f358 9500
B=00b8 cb75 1b00 and v is calculated based on N rather than on N_orig as v=0bd4 4478 and shift is set to logic 1 to indicate the shift.

In this example, with shift=1, the least-significant zeros of A are ignored, and the three digits used for A in the associated modular multiplication are:
a₂=0001
a₁=44f3
a₀=5895
   as if A were not left-shifted.

In a first iteration of an outer loop in this example, the following values are calculated:

$${a}_{2} {b}_{2} = 0001 \times 00 b 8 = \begin{matrix}0000 & 00 b 8\end{matrix} \\ {a}_{2} {b}_{1} = 0001 \times cb 75 = \begin{matrix}0000 & cb 75\end{matrix}$$

The step-by-step calculations of t and q for the first iteration of the outer loop in this example, with a summarized inner loop calculation of a corresponding intermediate value S, are as follows:

$$\begin{matrix}0 & 0000 & 0000 & 0000 \\ & 0000 & 00 b 8 & 0000 \\ & 0000 & 0000 & cb 75\end{matrix}$$

$$0 \qquad 0000 \qquad 00 b 8 \qquad cb 75$$

$$t = \begin{matrix}0 & 0000 & 00 b 8\end{matrix}$$

$${t}_{1} {v}_{1} = \begin{matrix}0 & 0000\end{matrix} \times 0 bd 4 = \begin{matrix}0 & 0000 & 0000\end{matrix}$$

$${t}_{1} {v}_{0} = \begin{matrix}0 & 0000\end{matrix} \times 4478 = \begin{matrix}0 & 0000 & 0000\end{matrix}$$

$${t}_{0} {v}_{1} = 36 a 0 \times 0 bd 4 = \begin{matrix}0286 & 1 c 80\end{matrix}$$

$$\begin{matrix}0 & 0000 & 0000 & 0000 \\ & 0 & 0000 & 0000 \\ & & 0286 & 1 c 80\end{matrix}$$

$$0 \qquad 0000 \qquad 0286 \qquad 1 c 80$$

$$q = \begin{matrix}0 & 0000 & 0286 & 1 c 80\end{matrix} / {2}^{20} = \begin{matrix}0 & 0000\end{matrix}$$

$$S = \begin{matrix}0 & 0000 & 0000 & 0000 & 0000\end{matrix} // {2}^{X} S + \begin{matrix}0000 & 00 b 8 & cb 75 & 1 b 00\end{matrix} //$$

$${a}_{2} B - \begin{matrix}0 & 0000 & 0000 & 0000 & 0000\end{matrix} // qN = \begin{matrix}0 & 00 b 8 & cb 75 & 1 b 00\end{matrix}$$

In a second iteration of the outer loop in this example, the following values are calculated:

$${a}_{1} {b}_{2} = 44 f 3 \times 00 b 8 = \begin{matrix}0031 & 8 ea 8\end{matrix} \\ {a}_{1} {b}_{1} = 44 f 3 \times cb 75 = \begin{matrix}36 cc & 340 f\end{matrix}$$

The step-by-step calculations of t and q for the second iteration of the outer loop in this example, with a summarized inner loop calculation of a corresponding intermediate value S are as follows:

$$\begin{matrix}0 & 00 b 8 & cb 75 & 0000 \\ & 0031 & 8 ea 8 & 0000 \\ & 0000 & 36 cc & 340 f\end{matrix}$$

$$0 \qquad 00 ea \qquad 90 e 9 \qquad 340 f$$

$$t = \begin{matrix}0 & 00 ea & 90 e 9\end{matrix}$$

$${t}_{1} {v}_{1} = \begin{matrix}0 & 00 ea\end{matrix} \times 0 bd 4 = \begin{matrix}0 & 000 a & cfc 8\end{matrix}$$

$${t}_{1} {v}_{0} = \begin{matrix}0 & 00 ea\end{matrix} \times 4478 = \begin{matrix}0 & 003 e & 95 b 0\end{matrix}$$

$${t}_{0} {v}_{1} = 90 e 9 \times 0 bd 4 = \begin{matrix}06 b 2 & 03 f 4\end{matrix}$$

$$\begin{matrix}0 & 000 a & cfc 8 & 0000 \\ & 0 & 003 e & 95 b 0 \\ & & 06 b 2 & 03 f 4\end{matrix}$$

$$0 \qquad 000 a \qquad d 6 b 8 \qquad 99 a 4$$

$$q = \begin{matrix}0 & 000 a & d 6 b 8 & 99 a 4\end{matrix} / {2}^{20} = \begin{matrix}0 & ad 6 b\end{matrix}$$

$$S = \begin{matrix}0 & 00 b 8 & cb 75 & 1 b 00 & 0000\end{matrix} // {2}^{X} S + \begin{matrix}0031 & c 574 & 3 b 54 & a 100\end{matrix} //$$

$${a}_{2} B - \begin{matrix}0 & 00 ea & 902 b & 8 dd 0 & f 000\end{matrix} // qN = \begin{matrix}0 & 00 bd & c 883 & b 100\end{matrix}$$

In a third (final) iteration of the outer loop in this example, the following values are calculated:

$${a}_{0} {b}_{2} = 5895 \times 00 b 8 = \begin{matrix}003 f & ab 18\end{matrix} \\ {a}_{0} {b}_{1} = 5895 \times cb 75 = \begin{matrix}4666 & a 319\end{matrix}$$

The step-by-step calculations of t and q for the third (final) iteration of the outer loop in this example, with summarized inner loop calculations of a corresponding intermediate value S and the difference D are as follows:

$$\begin{matrix}0 & 00 bd & c 883 & 0000 \\ & 003 f & ab 18 & 0000 \\ & 0000 & 4666 & a 319\end{matrix}$$

$$0 \qquad 00 fd \qquad ba 01 \qquad a 319$$

$$t = \begin{matrix}0 & 00 fd & ba 01\end{matrix}$$

$${t}_{1} {v}_{1} = \begin{matrix}0 & 00 fd\end{matrix} \times 0 bd 4 = \begin{matrix}0 & 000 b & b 084\end{matrix}$$

$${t}_{1} {v}_{0} = \begin{matrix}0 & 00 fd\end{matrix} \times 4478 = \begin{matrix}0 & 0043 & aa 98\end{matrix}$$

$${t}_{0} {v}_{1} = ba 01 \times 0 bd 4 = \begin{matrix}0898 & 13 d 4\end{matrix}$$

$$\begin{matrix}0 & 000 b & b 084 & 0000 \\ & 0 & 0043 & aa 98 \\ & & 0898 & 13 d 4\end{matrix}$$

$$0 \qquad 000 b \qquad b 95 f \qquad be 6 c$$

$$q = \begin{matrix}0 & 000 b & b 95 f & be 6 c\end{matrix} / {2}^{20} = \begin{matrix}0 & bb 95\end{matrix}$$

$$S = \begin{matrix}0 & 00 bd & c 883 & b 100 & 0000\end{matrix} // {2}^{X} S + \begin{matrix}003 f & f 17 e & ac 70 & b 700\end{matrix} //$$

$${a}_{2} B - \begin{matrix}0 & 00 fd & b 8 a 8 & 057 f & 1000\end{matrix} // qN = \begin{matrix}0 & 015 a & 57 f 1 & a 700\end{matrix}$$

$$D = \begin{matrix}0 & 015 a & 57 f 1 & a 700\end{matrix} // S - \begin{matrix}0 & 015 a & 433 e & d 000\end{matrix} // N = \begin{matrix}0 & 0000 & 14 b 2 & d 700\end{matrix}$$

In this example, D>0, so D is the final (fully reduced) modular multiplication result. In order to compensate for the left-shift operands, D can be right-shifted by one-half digit, or the trailing two zeros can be ignored, such that D is interpreted as 0000 0014 b2d7.

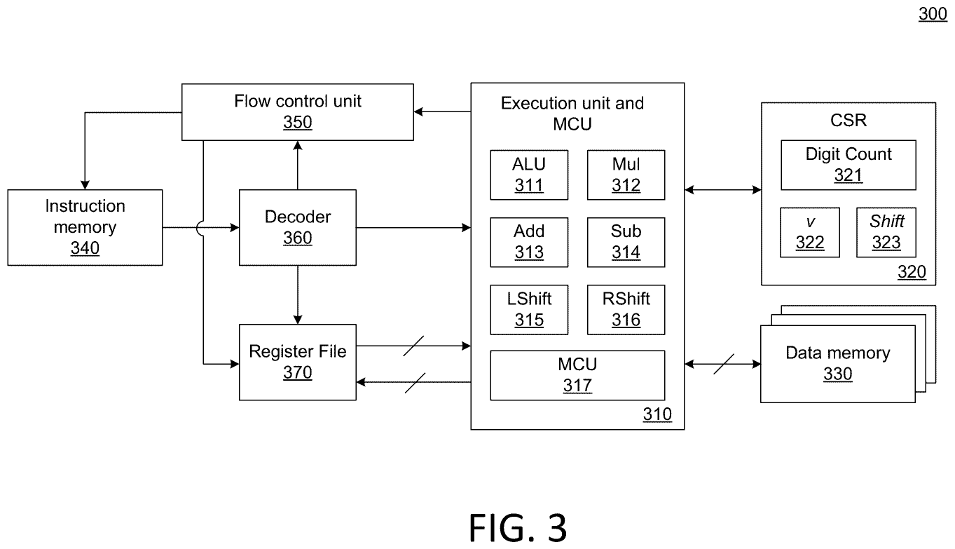

FIG. 3 is a block diagram schematically illustrating an example processor 300 that can implement an instruction for performing modular multiplication. The processor 300 includes an execution unit 310 (which include sub-components discussed below), control and status registers (CSRs 320), data memory (memory 330, e.g., RAM), instruction memory 340, a flow control unit 350, a decoder 360, and a register file 370. In some implementations, the components of the processor 300 can be arranged and/or grouped in other ways. The processor 300 is provided by way of example for purposes illustration. In this example, the execution unit 310 includes an arithmetic logic unit (ALU 311), a multiplier (Mul 312), an adder (Add 313), a subtractor (Sub 314), a left shifter (LShift 315), a right shifter (RShift 316), and a memory control unit (MCU 317), which can be implemented in a number of different ways, depending on the particular implementations and used, e.g., for performing modular multiplication calculations such as described herein.

As shown in FIG. 3, the CSRs 320 can include at least one register (or an array of registers) which can store values related to performing modular multiplication. For instance, the CSRs can store a digit count 321 (a number of respective digits in A, B, N, as well as S and D), a value for v 322 (e.g., v as described herein), and a value of shift 323 to indicate whether or not the operands of a modular multiplication command (A, B, N) are left-shifted in response to a most-significant half digit of N being zero. Depending on the particular implementations, two or more of the values stored in the CSRs 320 that are shown in FIG. 3 can be stored in a single register of the CSRs 320, or the values can each be stored in respective separate registers of the CSRs 320.

In this example, the processor 300 can be configured to execute a command (instruction) modular multiplication (e.g., AB mod N) using the approaches described herein, The instruction execution process can be implemented as follows. First, the flow control unit 350 can read an instruction (a modular multiplication instruction with A, B and N as operands) from the instruction memory 340, where the read instruction is provided to the decoder 360. The decoder 360 can then decode the instruction and determine it is a modular multiplication instruction, e.g., according to a corresponding opcode symbolically denoted in the drawings as BMMI_MUL.

Once decoded by the decoder 360, the execution unit 310 will then execute the decoded instruction. For example, an implicit pointer to the modulus N can be read from a register of the register file 370. The implicit pointer for N can reference (implicitly point to) a slot in the memory 330 (data memory) in which the modulus N is stored. After reading the implicit pointer for N, an implicit pointer that references a memory slot for intermediate results S can be read, e.g., from a corresponding register in the register file 370. Next, respective pointers corresponding with the operands A and B and the difference D are read, where those pointers reference (point to) respective memory slots in which A and B are stored, and a memory slot for storing D, once calculated by corresponding nested outer and inner loops (a first iterative loop and a second iterative loop nested in the first iterative loop).

Execution of the instruction can then proceed to reading the digit count 321, v 322 and shift 323 from the CSRs 320. In some implementations, v 322 can be calculated outside of the execution of the modular multiplication instructions, e.g., pre-calculated and pre-stored in the CSRs 320. Modular multiplication can then then be performed, e.g., using the approaches of the numerical examples described herein based on the various pointer and values as described for this example. The MCU 317 can control reading and writing of data from/to the memory 330 during modular multiplication.

That is, in this example, v 322 is used for calculating q at every iteration of an outer loop, digit count 321 is used to determine a number of respective iterations of both the inner loop and the outer loop, and shift 323 is used to determine whether to shift A one-half digit right for the modular multiplication process and whether to right-shift the final result after execution of the last iteration of the outer loop (and/or a subsequent subtraction loop). In some implementations, such right shifting can be omitted.

During the modular multiplication calculation, at all iterations of the outer loop, the intermediate result S is stored in the memory slot pointed to by its implicit pointer, and D, when calculated, is stored in the memory slot pointed to by a first operand. In some implementations, D is determined by a last instance of the inner loop of a final iteration of the outer loop. In other implementations, a subtraction loop can be performed after the last iteration of the outer loop.

Once D is calculated, a final (fully reduced) result is determined based on its value. If D<0, the pointer to D and the implicit pointer to S are swapped as, in this situation, the final intermediate result S is the fully reduced modular multiplication result. If, however, D≥0, the pointers are not swapped, as D is the fully reduced modular multiplication result. After the fully reduced result is determined, the flow control unit can increment an instruction pointer and the processor can proceed with execution of a next instruction as determined by the flow control unit 350, e.g., an instruction that follows a modular multiplication instruction in an execution flow of a corresponding program code.

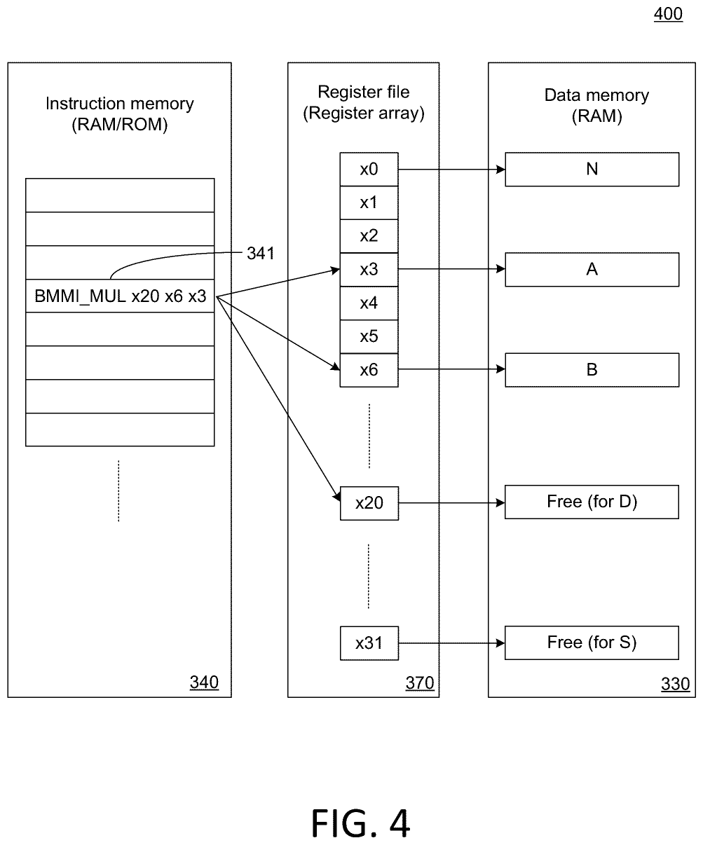

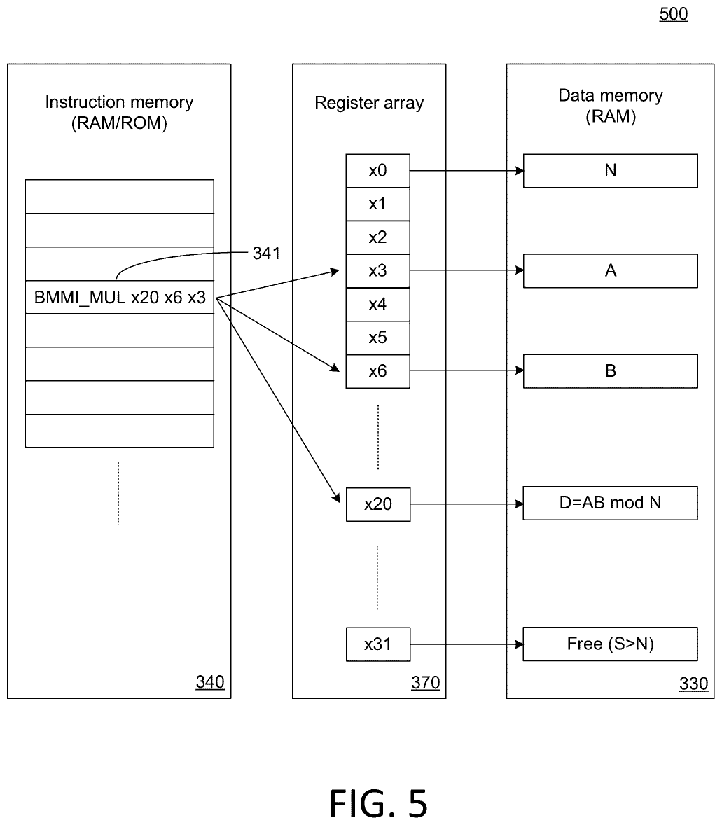

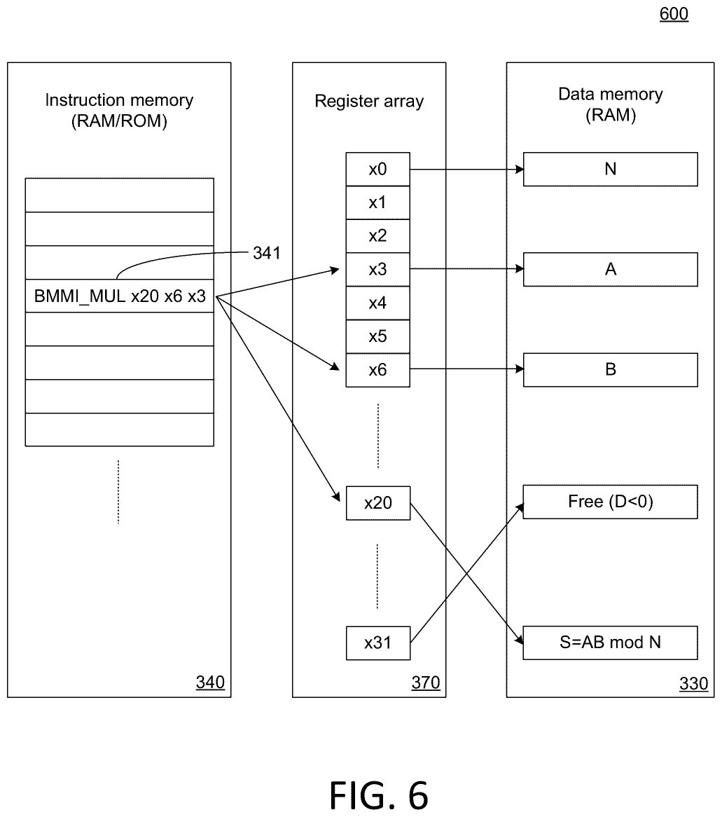

By way of further example, FIGS. 4, 5 and 6 illustrate example processor states associated with execution of a processor command for performing modular multiplication. FIG. 4 illustrates an example processor state (state 400) before, or at the onset of execution of a modular multiplication instruction. FIG. 5 illustrates an example processor state (state 500) after execution of a modular multiplication instruction where D≥0 and, therefore, D is the fully reduced result. FIG. 6 illustrates an example processor state (state 600) after execution of a modular multiplication instruction where D<0 and, therefore, S is the fully reduced result.

For this example, it is presumed that an instruction 341 stored in the instruction memory 340 is to calculate AB mod N. In this example N, A and B are stored in respective memory slots of the memory 330. In situations where A=B, a same memory slot can be used for A and B, as their values are equal and that value only needs to be represented once in the memory 330. Also in this example, it is presumed that digit count 321, v 322 and shift 323 are determined and stored as described with respect to FIG. 3 (e.g., in the CSRs 320).

As shown in FIGS. 4 to 6, a specific register (e.g., a first register x0) of a register file 370 (e.g., a register array) stores a pointer that implicitly points to the memory slot of N. A second register of the register file 370 (e.g., register x3) stores a pointer that points the memory slot for A, a third register of the register file 370 (e.g., register x6) stores a pointer that points to the memory slot for B, and a fourth register of the register file 370 (e.g., register x20) stores a pointer that points to the memory slot for D. Again, as noted above, if A=B, the second and third registers can point to the same memory slot. Further in this example, a fifth specific register of the register file 370 (e.g., register x31) stores a pointer than implicitly points to the memory slot for S.

As shown in FIGS. 4 to 6, a modular multiplication instruction 341 is represented as BMMI_MUL x20 x3 x6, where the operands x20, x3 and x6 are the registers storing the pointers to D, A, B, respectively. The state 400 at invocation of the instruction is shown in FIG. 4, where the memory slot for D is shown as Free (for D) and the memory slot for S is shown as Free (for S). These slots are indicated as free at this point, because they do not yet include useful data and are respectively free for values of D and S to be written. Modular multiplication is then performed (using the approached describe herein) to calculate S=AB q mod N and D=S−N, which are respectively stored in the slots pointed to by registers x31 and x20. In this example, as shown by FIG. 5, if D≥0, the pointers in registers x31 and x20 are not swapped (D=AB mod N). Also in this example, as shown by FIG. 6, if D<0, the pointers in registers x31 and x20 are swapped (S=AB mod N). In either of these situations, whether pointers are swapped or not, register x31 points to a slot with an incorrect final result, and that register and its associated memory slot can be overwritten (e.g., are free for use by subsequent operations). In this example, because the slot for D (register x20) is filled only in (or after) the last iteration of the outer loop, it may coincide with the slot for A or for B, as they are no longer needed once D is determined (or being determined digit-by-digit in the last instance of the inner loop).

As was discussed briefly above, the approaches (e.g., methods, processor instructions, etc.) for modular multiplication include features and aspects that provide a number of benefits over previous approaches For example, the approaches described herein allow for performing modular multiplication using a fixed (single) parameter set that is independent of a numerical value of an associated modulus, as compared with prior approaches that use different sets of parameters that are dependent on a numerical value of an associated modulus. Use of a fixed parameter set is facilitated by performing shifts (left and/or right) of associated operands and results, as is described here. Use of a fixed parameter set, as described herein, allows for full reduction (final reduction) of a modular multiplication result using a single long integer subtraction. In implementations using approaches for modular multiplication as described herein, final reduction for modular exponentiation operations can be performed one time, e.g., after the last multiplication. rather after each multiplication. In elliptic curve cryptography, where modular multiplication is interspersed with modular additions and subtractions, and a full reduction is performed before each addition or subtraction, the approaches described provide performance efficiency advantages over prior approaches.

Furthermore, because a single subtraction is used for full modular reduction, that modular reduction can be included in a last iteration (e.g., in an inner loop) of nested iterative loops used to performed the modular multiplication. Such implementations, as described herein, can allow for eliminating separate modular reduction. In hardware implementations (e.g., stand-alone modular multipliers, processors, etc.) such approaches can save computing resources including instruction processing time and memory resources. Additionally, in some implementations, as it is not known which one of the candidates for the final result (S or D) will be the valid, final (fully reduced) result, respective memory (RAM) addresses of the corresponding intermediate results (S) and difference (D) of a long calculation (e.g., a scalar multiplication on an elliptic curve) become data dependent, which can make attacks (e.g., side-channel attacks) more difficult.

Implementations in which a processor instruction is used for modular multiplication (e.g., as an instruction in a general purpose processor's instruction set) allow for flexibility for implementing cryptographic processes (e.g., including modular multiplication in combination with modular addition and/or modular subtraction), as such cryptographic processes can be implemented in firmware, rather than in hardware, allowing for those processes to be easily revised through a firmware update.

Additionally, swapping of pointers (for respective pointers to S and D) as described herein can simplify firmware for processes including modular multiplication, as it eliminates the need for manual swapping of registers (e.g., in response to checking an associated flag value indicating a correct fully reduced result). Also, in the approaches described herein, once the final result (between a final value of S and D) has been determined, one of the memory slots (the slot containing the invalid result) can be regarded as being free, e.g., the memory slot referenced by an implicit pointer.

In approaches described herein, built-in final reduction can allow for overwriting one of the operands of a modular multiplication when performing the final reduction, as those operands are no longer needed, which can reduce memory resources used as compared to prior approaches.

In a general aspect, a method for performing modular multiplication of a first integer and a second integer modulo a third integer in a modular multiplier of a cryptographic engine includes calculating a fourth integer corresponding with an inverse of the third integer based on a number of bits in the third integer, a digit size of the modular multiplier and a size coefficient. The size coefficient corresponds with an upper size limit for a result of the modular multiplication. The size coefficient is fixed and the upper size limit is a product of the size coefficient and the third integer. The method further include calculating a result of the modular multiplication using a plurality of modular reduction coefficients that are determined using the fourth integer, a respective digit of the first integer and at least two most significant digits of the second integer. The result has a value that is less than the upper size limit. The method also includes determining a final result of the modular multiplication based on a difference between the result and the third integer. If the difference is less than zero, the result is the final result, and if the difference is greater than or equal to zero, the difference is the final result.

Implementations can include one or more of the following features or aspects, alone or in combination. For example, the size coefficient can be less than or equal to two.

The method can include, prior to calculating the fourth integer, determining a value of a most-significant half of a most significant digit of the third integer. If the most-significant half is zero, the method can include performing a left-shift of the second integer by one half the digit size, performing a left-shift of the third integer by one half the digit size, calculating the fourth integer based on the left-shifted third integer, calculating the result of the modular multiplication based on the first integer, the left-shifted second integer, and the left-shifted third integer, and determining the final result by performing a right-shift of the final result by one half the digit size.

Calculating the result of the modular multiplication can include using a first iterative loop and a second iterative loop nested in the first iterative loop. The first iterative loop can be indexed over digits of the first integer from a most-significant digit to a least-significant digit. The second iterative loop is indexed over digits of the second integer from a least significant digit to a most significant digit.

The plurality of modular reduction coefficients used in the second iterative loop can be respectively determined in iterations of the first iterative loop before entering respective iterations of the second iterative loop.

Intermediate results of the modular multiplication can be determined in iterations of the second iterative loop. The final result can be determined after a last iteration of the first iterative loop.

Intermediate results of the modular multiplication can be determined in iterations of the second iterative loop. The final result can be determined in a last iteration of the first iterative loop.

The cryptographic engine can be implemented in a processor, and the method can be performed as result of executing a command of the processor.

In another general aspect, a processor includes a cryptographic engine configured to perform modular multiplication of a first integer and a second integer modulo a third integer. Performing the modular multiplication includes calculating a fourth integer corresponding with an inverse of the third integer based on a number of bits in the third integer, a digit size of a hardware multiplier of the processor and a size coefficient. The size coefficient corresponds with an upper size limit for a result of the modular multiplication. The size coefficient is fixed and the upper size limit is a product of the size coefficient and the third integer. Performing the modular multiplication further includes calculating a result of the modular multiplication using a plurality of modular reduction coefficients that are determined using the fourth integer, a respective digit of the first integer, and at least two most-significant digits of the second integer. The result has a value that is less than the upper size limit. Performing the modular multiplication also includes determining a final result of the modular multiplication based on a difference between the result and the third integer. If the difference is less than zero, the result is the final result. If the difference is greater than or equal to zero, the difference is the final result.

Implementations can include one or more of the following features or aspects, alone or in combination. For example, the modular multiplication can be performed by executing an instruction of the processor.

The instruction of the processor can have three operands including a first operand corresponding with the final result, a second operand corresponding with the second integer, and a third operand corresponding with the first integer.

The processor can include a register array including a plurality of registers, and a memory. The first operand can be a first register of the plurality of registers configured to store a first pointer to a first memory slot of the memory used to store the difference. The second operand can be a second register of the plurality of registers configured to store a second pointer to a second memory slot of the memory used to store the second integer. The third operand can be a third register of the plurality of registers configured to store a third pointer to a third memory slot of the memory used to store the first integer.

A fourth register of the plurality of registers can be configured to store a first implicit pointer to the third integer. A fifth register of the plurality of registers can be configured to store a second implicit pointer to the result. If the difference is less than zero, the processor can be configured to swap the first pointer and the second implicit pointer.

The fourth integer can be stored in a fourth register of the plurality of registers.

A number of digits included in each of the first integer, the second integer and the third integer can be stored in a sixth register of the plurality of registers.

If the first integer is equal to the second integer, the second pointer can be equal to the first pointer and the second memory slot and the third memory slot can be a same memory slot.

The first pointer can be equal to one of the second pointer, or the third pointer.

Performing the modular multiplication can include, prior to calculating the fourth integer, determining a value of a most-significant half of a most significant digit of the third integer. If the most-significant half is zero, Performing the modular multiplication can include performing a left-shift of the second integer by one half the digit size, performing a left-shift of the third integer by one half the digit size, calculating the fourth integer based on the left-shifted third integer, calculating the result of the modular multiplication based on the first integer, the left-shifted second integer, and the left-shifted third integer, and determining the final result by performing a right-shift of the final result by one half the digit size.

A bit indicating whether the first integer, the second integer, and the third integer are left-shifted can be stored in a register of the processor. If the bit indicates that the first integer, the second integer and the third integer are left shifted, the processor can be configured to right shift the first integer by one-half the digit size when performing modular multiplication.

The fourth integer can be stored in the register of the processor. A number of digits included in each of the first integer, the second integer, the third integer, the result, and the difference can be stored in the register of the processor.

Implementations of the various techniques described herein may be implemented in digital electronic circuitry, or in computer hardware, firmware, software, or in combinations of them. Implementations may be implemented as a computer program product, i.e., a non-transitory computer program tangibly embodied in an information carrier, e.g., in a machine-readable storage device (e.g., a computer-readable medium, a tangible computer-readable medium), for processing by, or to control the operation of, data processing apparatus, e.g., a programmable processor, a computer, or multiple computers. In some implementations, a non-transitory tangible computer-readable storage medium can be configured to store instructions that when executed cause a processor to perform a process. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be processed on one computer or on multiple computers at one site or distributed across multiple sites and interconnected by a communications network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the processing of a computer program include, by way of example, both general and special purpose microprocessors, and any one or more processors of any kind of digital computer. Generally, a processor will receive instructions and data from a read-only memory or a non-volatile memory or a random access memory or some or all of them. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT), a light emitting diode (LED), or liquid crystal display (LCD) display device, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A method for performing modular multiplication of a first integer and a second integer modulo a third integer in a modular multiplier of a cryptographic engine, the method comprising:
calculating a fourth integer corresponding with an inverse of the third integer based on a number of bits in the third integer, a digit size of the modular multiplier and a size coefficient, the size coefficient corresponding with an upper size limit for a result of the modular multiplication, the size coefficient being fixed and the upper size limit being a product of the size coefficient and the third integer;
calculating a result of the modular multiplication using a plurality of modular reduction coefficients that are determined using the fourth integer, a respective digit of the first integer and at least two most significant digits of the second integer, the result having a value that is less than the upper size limit; and
determining a final result of the modular multiplication based on a difference between the result and the third integer, wherein if the difference is less than zero, the result is the final result, and if the difference is greater than or equal to zero, the difference is the final result.

2. The method of claim 1, wherein the size coefficient is less than or equal to two.

3. The method of claim 1, further comprising, prior to calculating the fourth integer:
determining a value of a most-significant half of a most significant digit of the third integer; and
if the most-significant half is zero:
performing a left-shift of the second integer by one-half the digit size;
performing a left-shift of the third integer by one-half the digit size;
calculating the fourth integer based on the left-shifted third integer;
calculating the result of the modular multiplication based on the first integer, the left-shifted second integer, and the left-shifted third integer; and
determining the final result by performing a right-shift of the final result by one-half the digit size.

4. The method of claim 1, wherein calculating the result of the modular multiplication includes using a first iterative loop and a second iterative loop nested in the first iterative loop, and wherein:
the first iterative loop is indexed over digits of the first integer from a most-significant digit to a least-significant digit, and
the second iterative loop is indexed over digits of the second integer from a least significant digit to a most significant digit.

5. The method of claim 4, wherein the plurality of modular reduction coefficients used in the second iterative loop are respectively determined in iterations of the first iterative loop before entering the second iterative loop.

6. The method of claim 4, wherein:
intermediate results of the modular multiplication are determined in iterations of the second iterative loop; and
the difference and the final result are determined after a last iteration of the first iterative loop.

7. The method of claim 4, wherein:
intermediate results of the modular multiplication are determined in iterations of the second iterative loop; and
the final result is determined in a last iteration of the first iterative loop.

8. The method of claim 1, wherein:
the cryptographic engine is implemented in a processor; and
the method is performed as result of executing a command of the processor.

9. A processor comprising:
a cryptographic engine configured to perform modular multiplication of a first integer and a second integer modulo a third integer, wherein performing the modular multiplication includes:
calculating a fourth integer corresponding with an inverse of the third integer based on a number of bits in the third integer, a digit size of a hardware multiplier of the processor and a size coefficient, the size coefficient corresponding with an upper size limit for a result of the modular multiplication, the size coefficient being fixed and the upper size limit being a product of the size coefficient and the third integer;
calculating a result of the modular multiplication using a plurality of modular reduction coefficients that are determined using the fourth integer, a respective digit of the first integer and at least two most-significant digits of the second integer, the result having a value that is less than the upper size limit; and
determining a final result of the modular multiplication based on a difference between the result and the third integer, wherein if the difference is less than zero, the result is the final result, and if the difference is greater than or equal to zero, the difference is the final result.

10. The processor of claim 9, wherein the modular multiplication is performed by executing an instruction of the processor.

11. The processor of claim 10, wherein the instruction of the processor has three operands including:
a first operand corresponding with the final result;
a second operand correspond with the second integer; and
a third operand corresponding with the first integer.

12. The processor of claim 11, further comprising:
a register array including a plurality of registers; and
a memory,
wherein:
the first operand is a first register of the plurality of registers configured to store a first pointer to a first memory slot of the memory used to store the difference;
the second operand is a second register of the plurality of registers configured to store a second pointer to a second memory slot of the memory used to store the second integer; and
the third operand is a third register of the plurality of registers configured to store a third pointer to a third memory slot of the memory used to store the first integer.

13. The processor of claim 12, wherein:
a fourth register of the plurality of registers is configured to store a first implicit pointer to the third integer;
a fifth register of the plurality of registers is configured to store a second implicit pointer to the result; and
if the difference is less than zero, the processor is configured to swap the first pointer and the second implicit pointer.

14. The processor of claim 12, wherein the fourth integer is stored in a fourth register of the plurality of registers.

15. The processor of claim 12, wherein a number of digits included in each of the first integer, the second integer and the third integer is stored in a sixth register of the plurality of registers.

16. The processor of claim 12, wherein, if the first integer is equal to the second integer, the second pointer is equal to the first pointer and the second memory slot and the third memory slot are a same memory slot.

17. The processor of claim 12, wherein the first pointer is equal to one of:
the second pointer; or
the third pointer.

18. The processor of claim 9, wherein performing the modular multiplication further includes, prior to calculating the fourth integer:
determining a value of a most-significant half of a most significant digit of the third integer; and
if the most-significant half is zero:
performing a left shift of the first integer by one-half the digit size;
performing a left-shift of the second integer by one-half the digit size;
performing a left-shift of the third integer by one-half the digit size;
calculating the fourth integer based on the left-shifted third integer; and
determining the final result of the modular multiplication based on the first integer, the left-shifted second integer, and the left-shifted third integer.

19. The processor of claim 18, wherein determining the final result includes performing a right-shift of the final result by one half the digit size.

20. The processor of claim 18, wherein:
a bit indicating whether the first integer, the second integer, and the third integer are left-shifted is stored in a register of the processor; and
if the bit indicates that the first integer, the second integer and the third integer are left shifted, the processor is configured to right shift the first integer by one-half the digit size when performing modular multiplication.

21. The processor of claim 20, wherein the fourth integer is stored in the register of the processor.

22. The processor of claim 21, wherein a number of digits included in each of the first integer, the second integer, the third integer, the result, and the difference is stored in the register of the processor.
